(19) United States
(12) Patent Application Publication
(10) Pub. No.: US 2014/0225988 A1
(43) Pub. Date: Aug. 14, 2014

(54) SYSTEM AND METHOD FOR THREE-DIMENSIONAL SURFACE IMAGING

(71) Applicant: COMMONWEALTH SCIENTIFIC AND INDUSTRIAL RESEARCH ORGANISATION, Campbell (AU)

(72) Inventor: George Vladimir Poropat, Campbell (AU)

(21) Appl. No.: 14/343,157

(22) PCT Filed: Sep. 7, 2012
(86) PCT No.: PCT/AU2012/001073

§ 371 Date: Apr. 15, 2014

(30) Foreign Application Priority Data
Sep. 7, 2011 (AU) 2011903647

(51) Int. Cl. G01B 11/14; H04N 13/02

(52) U.S. Cl. CPC G01B 11/14; H04N 13/0203
USPC 348/46

(57) ABSTRACT

The present invention provides a system and method (400) of generating a three-dimensional model of an object. The method (400) includes capturing first image and range data corresponding to a first portion of the object from at least two different positions (step 405) and generating a first three-dimensional model of the first portion of the object using the first image and range data (step 410). The method further includes capturing second image and range data corresponding to a second portion of the object from at least two different positions and generating a second three-dimensional model of the second portion of the object using the second image and range data (step 415). The first and second portions are overlapping. Finally, a third three-dimensional model is generated describing the first and second portions of the object by combining the first and second three-dimensional models into a single three-dimensional model (step 420).

### FIELD OF THE INVENTION

The present invention relates in general to systems and methods for the production of three-dimensional models. In particular although not exclusively the present invention relates to the use and creation in real or near real-time of large scale three-dimensional models of an object.

### BACKGROUND OF THE INVENTION

In many three-dimensional imaging applications of the prior art, a point cloud of spatial measurements representing points on a surface of a subject/object is created. These points can then be used to represent the shape of the subject/object and to construct a three-dimensional model of the subject/object. The acquisition of these data points is typically done via the use of three-dimensional scanners that measure distance from a reference point on a sensor to the subject/object. This may be done using contact or non-contact scanners.

Contact scanners, as the name suggests, require some form of tactile interaction with the object/subject. Scanning via contact with the object/subject provides a great deal of accuracy but it is exceptionally slow and in some instances can damage the object. For this reason non-contact systems tend to be preferred for most applications.

Non-contact scanners can generally be classified into two categories, active and passive. Active non-contact scanners illuminate the scene (object) with electromagnetic radiation such as visible light, short wave or long wave infrared radiation, x-rays etc., and detect signals reflected back from the scene to produce the point cloud. Passive scanners by contrast rely on creating spatial measurements from reflected ambient radiation.

Some of the more popular forms of active scanners are laser scanners, which use one or more lasers to sample the surface of the object. There are two main techniques for obtaining samples with laser based scanning systems, namely time of flight scanners and triangulation based systems.

Time-of-flight laser scanners emit a pulse of light that is incident on the surface of interest, and then measure the amount of time between transmission of the pulse and reception of the corresponding reflected signal. This round trip time is used to calculate the distance from the transmitter to the point of interest. In essence time of flight laser scanning systems are laser range finders which only detect the distance of one or more points within the direction of view at an instant. Thus to obtain a point cloud a typical time of flight scanner is required to scan the object one point at a time. This is done by changing the range finder's direction of view either by rotating the range finder itself, or by using a system of rotating mirrors or other means of directing the beam of electromagnetic radiation.

Triangulation based laser scanners create a three-dimensional image by projecting a laser dot or line or some structured (known) pattern on to the object, and a sensor is then used to detect the location of the dot or line or the components of the pattern. Depending on the relative geometry of the laser, the sensor and the surface, the dot or line or pattern element appears at different points within the sensor's field of view. The location of the dot on the surface or of points within the line or the pattern can be determined by the fixed relationship between the laser source and the sensor.

With these laser scanner systems data is collected with reference to an internal coordinate system associated with the scanner/sensor position and measurements are thus relative to the scanner.

However, a problem with laser scanners of the prior art is that they typically are not able produce a complete model of a large or complex object.

An alternate approach to the construction of three-dimensional images is the use of photogrammetry. Essentially this process utilises triangulation between two or more images to locate the spatial co-ordinates of a point in space relative to the image capturing device(s). With photogrammetry image coordinates for a given point on an object are measured from at least two images. More specifically rays to a point on the object are projected from the image centre, and the intersection point of the rays provides the estimate of the spatial coordinates for the point on the object. This can be readily calculated utilising triangulation. As such, transition between edges (joints, cracks) etc can be determined with a high degree of accuracy. A disadvantage however, is that detail of low contrasting surfaces or reflective surfaces can be lost in some cases.

### SUMMARY OF THE INVENTION

According to a first aspect, the present invention provides a method of generating a three-dimensional model of an object, the method including:

(a) capturing, using at least one image sensor and at least one range sensor, first image and range data corresponding to a first portion of the object from at least two different positions;

(b) generating, by a processor, a first three-dimensional model of the first portion of the object using the first image and range data;

(c) capturing, using at least one image sensor and at least one range sensor, second image and range data corresponding to a second portion of the object from at least two different positions, wherein the first and second portions are overlapping;

(d) generating, by a processor, a second three-dimensional model of the second portion of the object using the second image and range data; and

(e) generating, by a processor, a third three-dimensional model describing the first and second portions of the object by combining the first and second three-dimensional models into a single three-dimensional model.

Preferably, the first image and range data comprises range data that is of lower resolution than the image data.

Preferably, the method further comprises estimating relative positions of the at least one image sensor at the at least two different positions by matching spatial features between images of the first image and range data.

According to certain aspects, the method further comprises:

estimating position and orientation data of the at least one image sensor and the at least one range sensor at one of the at least two different positions; and

partially initialising the matching of spatial features using the position and orientation data.

Preferably, the position and orientation data comprises a position determined relative to another position using acceleration data.

Preferably, the second image and range data is captured subsequently to generation of the first three-dimensional model.

According to certain aspects, a position of the at least two positions from which the first image and range data is captured and a position of the at least two positions from which the second image and range data is captured comprises a common position.

Preferably, the first and second three-dimensional models are generated on a first device, and the third three-dimensional model is generated on a second device. This enables generation of sequential overlapping three-dimensional models locally before transmitting the images to a remote terminal for display and further processing.

Preferably, capturing the range data comprises projecting a coded image onto the object, and analysing the reflected coded image.

Preferably, the method further comprises: presenting, on a data interface, the third three-dimensional model. This enables a user to view the three-dimensional model, for example as it is being created. If scanning an object, this can aid the user in detecting parts of the object that are not yet scanned.

Preferably, the method further comprises:

generating a plurality of three dimensional models at different time instances; and

determining, by comparing the plurality of three-dimensional models, changes to the object over time.

According to a second aspect, the present invention resides in a system for generating a three-dimensional model of an object, the system including:

at least one processor;

at least one image sensor coupled to the at least one processor;

at least one range sensor coupled to the at least one processor; and

a memory coupled to the at least one processor, including instruction code executable by the at least one processor for:
(a) capturing, using the at least one image sensor and the at least one range sensor, first image and range data corresponding to a first portion of the object from at least two different positions;
(b) generating a first three-dimensional model of the first portion of the object using the first image and range data;
(c) capturing, using the at least one image sensor and the at least one range sensor, second image and range data corresponding to a second portion of the object from at least two different positions, wherein the first and second portions are overlapping;
(d) generating a second three-dimensional model of the second portion of the object using the second image and range data; and
(e) generating a third three-dimensional model describing the first and second portions of the object by combining the first and second three-dimensional models into a single three-dimensional model.

Preferably, a range sensor of the at least one range sensor has a lower resolution than an image sensor of the at least one image sensor. More preferably, the range sensor comprises at least one of a lidar, a flash lidar, and a laser range finder.

Preferably, the system further comprises:

a sensor module, coupled to the at least one processor, for estimating position and orientation data of the at least one image sensor and the at least one range sensor;

wherein the feature matching is at least partly initialised using the position and orientation data.

Preferably, the at least one processor, the at least one image sensor, the at least one range sensor, the processor and the memory are housed in a hand held device. More preferably, the first and second three-dimensional models are generated by a first processor of the at least one processor on a first device, and the third three-dimensional model is generated by a second processor of the at least one processor on a second device.

According to certain embodiments, the at least one range sensor comprises a projector, for projecting a coded image onto the object, and a sensor for analysing the projected coded image.

Preferably, the system further comprises a display screen, for displaying the third three-dimensional model.

According to a third aspect, the invention resides in a system for generating a three-dimensional model of an object, the system including:

a handheld device including:
a processor;
a network interface coupled to the processor;
an image sensor coupled to the processor;
a range sensor coupled to the processor; and
a memory coupled to the processor, including instruction code executable by the processor for:
   capturing, using the image sensor and the range sensor, first image and range data corresponding to a first portion of the object from at least two different positions;
   generating a first three-dimensional model of the first portion of the object using the first image and range data;
   capturing, using the image sensor and the range sensor, second image and range data corresponding to a second portion of the object from at least two different positions, wherein the first and second portions are overlapping;
   generating a second three-dimensional model of the second portion of the object using the second image and range data; and
   transmitting, by the network interface, the first and second three-dimensional models;

a server including:
a processor;
a network interface coupled to the processor;
a memory coupled to the processor, including instruction code executable by the processor for:
   receiving, on the network interface, the first and second three-dimensional models; and
   generating a third three-dimensional model describing the first and second portions of the object by combining the first and second three-dimensional models into a single three-dimensional model.

### BRIEF DETAILS OF THE DRAWINGS

In order that this invention may be more readily understood and put into practical effect, reference will now be made to the accompanying drawings, which illustrate preferred embodiments of the invention, and wherein:

FIG. 1 illustrates a system for the generation of a three-dimensional model of an object, according to one embodiment of the present invention;

FIG. 2 illustrates a system for the generation of a three-dimensional model of an object, according to another embodiment of the present invention;

FIG. 3 illustrates a system for the generation of a three-dimensional model of an object utilising a stereo image sensor arrangement, according to another embodiment of the present invention;

FIG. 4 illustrates a method of generating a three-dimensional model, according to an embodiment of the present invention; and

FIG. 5 diagrammatically illustrates a computing device, according to an embodiment of the present invention.

Those skilled in the art will appreciate that minor deviations from the layout of components as illustrated in the drawings will not detract from the proper functioning of the disclosed embodiments of the present invention.

### DESCRIPTION OF EMBODIMENTS OF THE INVENTION

Embodiments of the present invention comprise systems and methods for the generation of three-dimensional models. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to one aspect, the invention resides in a method of generating a three-dimensional model of an object, the method including: capturing, using at least one image sensor and at least one range sensor, first image and range data corresponding to a first portion of the object from at least two different positions; generating, by a processor, a first three-dimensional model of the first portion of the object using the first image and range data; capturing, using at least one image sensor and at least one range sensor, second image and range data corresponding to a second portion of the object from at least two different positions, wherein the first and second portions are overlapping; generating, by a processor, a second three-dimensional model of the second portion of the object using the second image and range data; and generating, by a processor, a third three-dimensional model describing the first and second portions of the object by combining the first and second three-dimensional models into a single three-dimensional model.

Advantages of certain embodiments of the present invention include an ability to produce an accurate three-dimensional model with sufficient surface detail to identify structural features on the surface of the scanned object in real time or near real time. Certain embodiments include presentation of the three-dimensional model as it is being generated, which enables more efficient generation of the three-dimensional model as a user is made aware of the sections that have been processed (and thus the sections that have not).

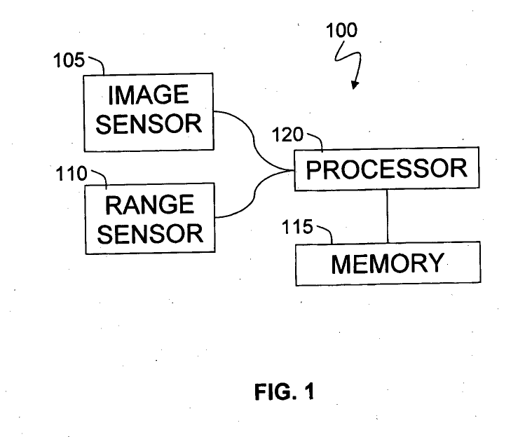

FIG. 1 illustrates a system 100 for the generation of a three-dimensional model of an object, according to one embodiment of the present invention. The term object is used in a broad sense, and can describe any type of object, living or otherwise, including human beings, rock walls, mine sites and man-made objects. Furthermore, the invention is particularly suited to complex and large objects, or where only a portion of the object is visible from a single point.

The system 100 includes an image sensor 105, a range sensor 110, a memory 115, and a processor 120. The processor 120 is coupled to the image sensor 105, the range sensor 110 and the memory 115.

The image sensor 105 is for capturing a set of two-dimensional images of portions of the object, and can, for example, comprise a digital camera, a charge-coupled device (CCD), or a digital video camera.

The range sensor 110 is for capturing range data corresponding to the same portions of the object captured by the image sensor 105. This can be achieved by arranging the image sensor 105 and the range sensor 110 in a fixed relationship such that they are directed in substantially the same direction and capture data simultaneously.

The range data is used to produce a set of corresponding range images, each of the set of range images corresponding to an image of the set of images. Each range image is essentially a depth image of a surface of the object for a position and orientation of the system 100. There are a variety of ways in which the range data can be obtained, for example the range sensor 110 can employ a lidar, laser range finder or the like.

One such range sensor 110 for use in the system 100 is the PrimeSensor flash lidar device marketed by PrimeSense. This PrimeSensor utilises an infrared (IR) light source to project a coded image onto the scene or object of interest. More specifically the PrimeSensor units operate using a modulated signal from which the phase of the returned signal is determined and from that the range to the surface is determined. A sensor is then utilised to receive the reflected signals corresponding to the coded image. The unit then processes the reflected IR image and produces an accurate per-frame depth image of the scene or object of interest.

The memory 115 includes computer readable instruction code, executable by the processor, for generating three-dimensional models of different portions of the object. This is done using image data captured by the image sensor 105 and range data captured by the range sensor 110. Using initially the range data, and refined by using the image data, the processor 120 can estimate relative positions of image sensor 105 and the range sensor 110 when capturing data corresponding to a common portion of the object from first and second positions. Using the estimated relative positions of the sensors 105, 110, the processor 120 is able to create a three-dimensional model of a portion of the object.

The process is then repeated for different portions of the object, such that each portion is partially overlapping with the previous portion.

Finally, a high resolution three-dimensional model is generated describing the different portions of the object. This is done by integrating data of the three-dimensional models into a single three-dimensional model.

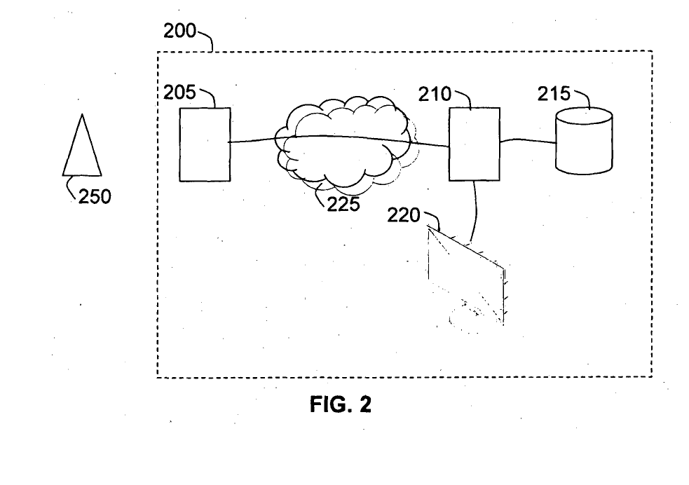

FIG. 2 illustrates a system 200 for the generation of a three-dimensional model of an object 250, according to another embodiment of the present invention. The system 200 comprises a handheld device 205, a server 210, a data store 215 connected to the server 210, and a display screen 220 connected to the server 210. The handheld device 205 and the server 210 can communicate via a data communications network 225, such as the Internet.

The handheld device 205 includes an image sensor (not shown), a range sensor (not shown), a processor (not shown) and a memory (not shown), similar to the system 100 of FIG. 1. Furthermore, the handheld device 205 includes a position sensing module (not shown), for estimating a location and/or an orientation of the handheld device 205.

A set of two-dimensional images of the object 250 are captured by the handheld device 205. At the time each image is captured a position and orientation of the handheld device 205 is estimated by the position sensing module.

As will be appreciated by those of skill in the art, the position and orientation of the handheld device 205 can be estimated in a variety of ways. In the system 200 the position and orientation of the handheld device 205 is estimated using the position sensing module. The position sensing module preferably includes a triple-axis accelerometer and triple-axis orientation sensor. The pairing of these triple-axis sensors provides 6 parameters to locate the position of the imaging device relative to another position (i.e. 3 translational (x,y,z) and 3 angles of rotation (ω,φ,κ)).

Furthermore, an external sensor or tracking device can be used to estimate a position and/or orientation of the handheld device 205. The external sensor can be used to estimate a position and/or orientation of the handheld device 205 without other input, or together with other data, such as data from the position sensing module. The external sensor or tracking device can comprise an infrared scanning device, such as the Kinect motion sensing input device by Microsoft Inc. of Washington, USA, or the LEAP 3D motion sensor by Leap Motion Inc. of California, USA.

During the image capture, range information from the current position and orientation of the handheld device 205 to the object 250 is captured via the ranging unit, as discussed above.

To produce a three-dimensional model from the captured images, the handheld device 205 firstly pairs successive images. The handheld device 205 then calculates a relative orientation for the image pair. The handheld device 205 calculates the relative orientation based on a relative movement of the handheld device 205 from a first position from where the first image of the pair was captured, to a second position where the second image of the pair was captured.

The relative orientation can be estimated using a coplanarity or colinearity condition, an essential matrix, or any other suitable method.

The position and orientation data from the position sensing module alone is sometimes not accurate enough for three-dimensional image creation but can be used to initialise image matching methods. For example, the position and orientation data can be used to set up an initial estimate for the coplanarity of relative orientation solutions due to their limited convergence range.

Once the relative orientation is calculated for a given pair of images, it is then possible to calculate the spatial co-ordinates for each point in the pair of images using image feature matching techniques and photogrammetry (i.e. for each sequential image pair a matrix of three-dimensional spatial co-ordinates measured relative to the handheld device 205 is produced). To reduce processing time in the calculation, the information from the corresponding range images for the image pair is utilised to set initial image matching parameters.

The spatial co-ordinates are then utilised to produce a three-dimensional model of the portion of the object 250. The three-dimensional model of the portion of the object 250 is then sent to the server 210 via the data communications network 225.

The three-dimensional model of the portion of the object 250 can then be displayed to the user on the display 220 to provide feedback as to positioning of the handheld device 205 during the course of a scan. The three-dimensional model of the portion of the object 250 can then be stored in a data store 215 for further processing to produce a complete/high resolution three-dimensional model of the object 250, or be processed as it is received.

This process is repeated for subsequent image pairs as the handheld device 205 is scanned over the object 250.

In order to produce the complete/high resolution three-dimensional model, the three-dimensional models corresponding to the subsequent image pairs are merged. According to certain embodiments, the three-dimensional models are merged at the server 210 as they are received. In other words, the complete/high resolution three-dimensional model is gradually built as data is made available. According to alternative embodiments, all three-dimensional models are merged in a single step.

The merging of the three-dimensional models can be done via a combination of matching of feature points in the three-dimensional models and matching of the spatial data points via the use of the trifocal or quadrifocal tensor for simultaneous alignment of three or four three-dimensional models (or images rendered therefrom). An alternate approach could be to utilise point matching or shape matching as used in simultaneous localisation and mapping systems.

In each case the three-dimensional models must first be aligned. Alignment of the three-dimensional models is done utilising a combination of image feature points, derived spatial data points, range data and orientation data. When the alignment has been set up, the three-dimensional models are transformed to a common coordinate system. The resultant three-dimensional model is then displayed to the user on the display screen 220.

As discussed earlier, the further processing of the images to form the complete model can be done in real time, i.e. as a three-dimensional model segment is produced it is merged with the previous three-dimensional model segment(s) to produce the complete model. Alternatively the model generation may be done at a later stage to enable additional image manipulation techniques to be utilised to refine the data comprising the three-dimensional image, e.g. filtering, smoothing, or use of multiple point projections.

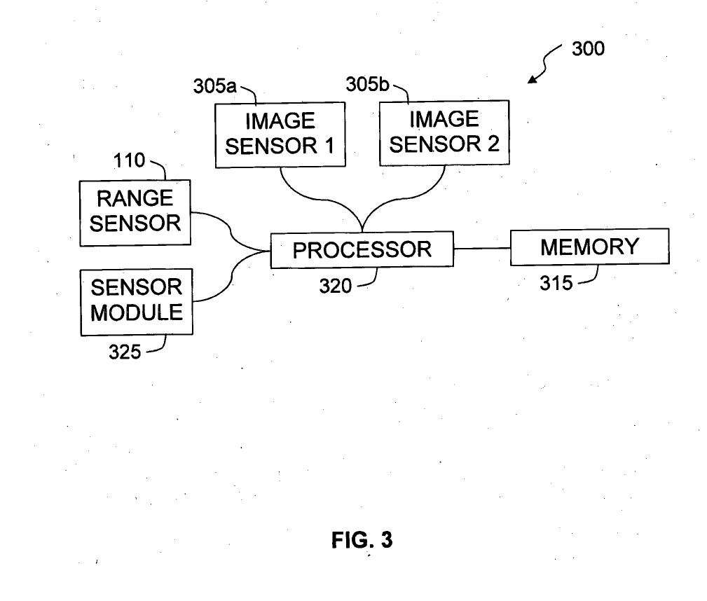

FIG. 3 depicts a system 300 for the generation of a three-dimensional model of an object utilising a stereo image sensor arrangement, according to another embodiment of the present invention. As shown, a pair of imaging sensors 305a, 305b having a fixed spatial relation are used to capture a set of synchronised two-dimensional images (i.e. overlapping stereo images). The system 300 also includes a range sensor 110, and a sensor module 325. The range sensor 110 and the sensor module 325 is associated of with one of the pair of imaging sensors 305a, 305b, e.g. the first imaging sensor 305a.

The imaging sensors 305a, 305b, range sensor 110 and sensor module 325 are coupled to a processor 320, which is in turn, connected to a memory 315. The memory 315 includes instruction code, executable by the processor 320, for performing the methods described below.

The relative position data provided by the sensor module 325 can be utilised to calculate the relative orientation of the system 300 between the capture of successive overlapping stereo images. As will be appreciated by those of skill in the art, the position of only one of the imaging sensors 305a, 305b in space need be known to calculate the position of the other imaging sensor 305a, 305 given the fixed relationship between the two imaging sensors 305a, 305b. Range sensor 110 simultaneously captures range information from the current position and orientation of the system 300 to the object to produce a range image. Again the range image is essentially a depth image of the surface of the object relative to the particular position of the system 300.

As the pair of imaging sensors 305a, 305b are arranged in a fixed relation, the relative orientation of the imaging sensors 305a, 305b is known a priori and it is possible to create a three-dimensional model for each position of the system 300 from the stereo image pairs. The relative orientation of the image sensors 305a, 305b may be checked each time or some times when a stereo pair is captured to ensure that the configuration of the system 300 has not been altered accidentally or deliberately. Utilising the synchronised images and the relative orientation it is possible to determine spatial co-ordinates for each pixel in a corresponding three-dimensional model. The spatial coordinates are three-dimensional points measured relative to the imaging sensors 305a, 305b. Once again, the range data is used to initialise the processing parameters to speed the three-dimensional model creation from the stereo images. In all cases the range data can be used to check the three-dimensional model.

The result is a three-dimensional model representing a portion of the object which includes detail of the surface of the portion of the object. This three-dimensional model can then be displayed to the user to provide real time or near real time feedback as to positioning of the system 300 to ensure that a full scan of the object or the particular portion of the object is obtained. The models may then be stored for further processing.

According to certain embodiments, three-dimensional models are also created using sequential stereo images. In this case, an image from the second imaging sensor 305b at a first time instant can be used together with an image from the first imaging sensor 305a at a second time instant. In this way, a further three-dimensional model can be generated using a combination of stereo image pairs, or single images from separate stereo image pairs.

The three-dimensional models for each orientation of the system 300 are merged to form a complete/high resolution three-dimensional model of the object. The process of merging the set of three-dimensional models can be done via a combination of matching of feature points in the images and matching of the spatial data points, point matching or shape matching etc. When all the three-dimensional models have been aligned to create a complete/high resolution three-dimensional model of the object being scanned, post processing can be used to refine the alignment of the three-dimensional models. The complete/high resolution three-dimensional model can then be displayed to the user.

In one embodiment of the present invention the spatial data points are combined with the range data to produce enhanced spatial data of the object for the given position and orientation of the system 300. In order to merge the range data, it must firstly be aligned with the spatial data. This is done utilising the relative orientation of the system 300 as calculated from the position data and the relative orientation of the imaging sensors 305a, 305b. The resulting aligned range data is essentially a matrix of distances from each pixel to the actual surface. This depth information can then be integrated into the three-dimensional model by interpolation of adjacent scan points i.e. the depth information and spatial co-ordinates are utilised to calculate the spatial coordinates (x,y,z) for each pixel.

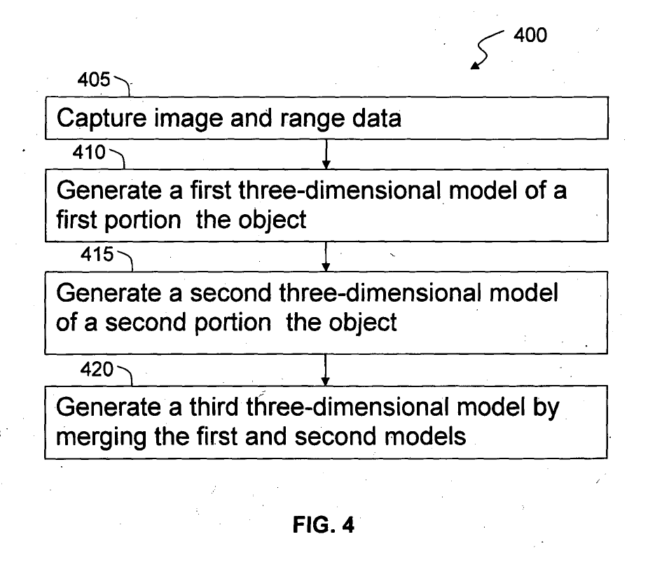

FIG. 4 illustrates a method of generating a three-dimensional model, according to an embodiment of the present invention.

At step 405, image data and range data is captured using at least one image sensor and at least one range sensor. The image data and range data corresponds to at least first and second portions of the object, wherein the first and second portions are overlapping.

At step 410, a first three-dimensional model of the first portion of the object is generated. The first three-dimensional model is generated using the image data and range data, and by estimating relative positions of the at least one image sensor and the at least one range sensor at first and second positions. The first and second positions correspond to locations where the image and range data corresponding to the first portion of the object were captured.

At step 415, a second three-dimensional model of the second portion of the object is generated. The second three-dimensional model is generated using the image data and range data, and by estimating relative positions of the at least one image sensor and the at least one range sensor at third and fourth positions. The third and fourth positions correspond to locations where the image and range data-corresponding to the second portion of the object were captured.

At step 420 a third three-dimensional model is generated, describing the first and second portions of the object. This is done by combining data of the first and second three-dimensional models into a single three-dimensional model, as discussed above.

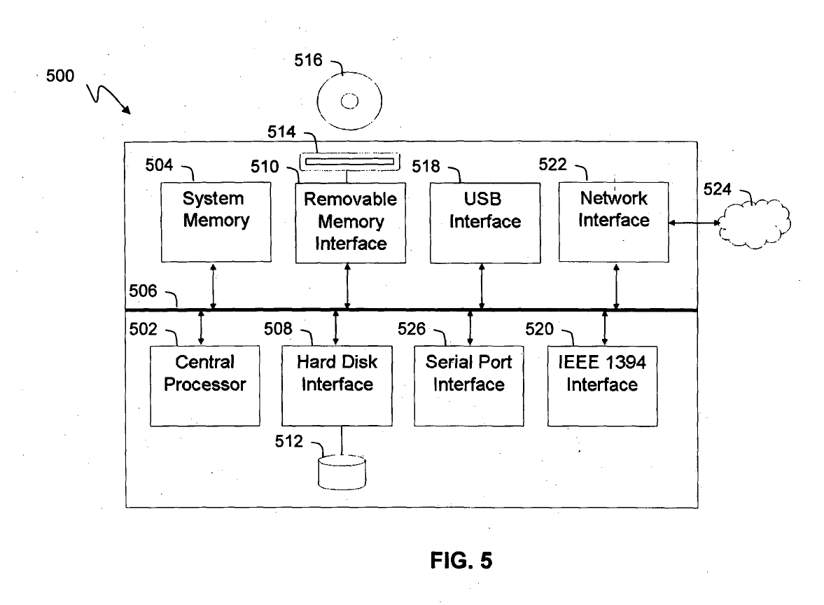

FIG. 5 diagrammatically illustrates a computing device 500, according to an embodiment of the present invention. The handheld device 205 and/or the server 210 of FIG. 2, can be identical to or similar to the computing device 500 of FIG. 5. Similarly, the method 400 of FIG. 4, and the systems 100 and 300 of FIGS. 1 and 3 can be implemented using the computing device 500.

The computing device 500 includes a central processor 502, a system memory 504 and a system bus 506 that couples various system components, including coupling the system memory 504 to the central processor 502. The system bus 506 may be any of several types of bus structures including a memory bus or memory controller, a peripheral bus, and a local bus using any of a variety of bus architectures. The structure of system memory 504 is well known to those skilled in the art and may include a basic input/output system (BIOS) stored in a read only memory (ROM) and one or more program modules such as operating systems, application programs and program data stored in random access memory (RAM).

The computing device 500 can also include a variety of interface units and drives for reading and writing data. The data can include, for example, the image data, the range data, and/or the three-dimensional model data.

In particular, the computing device 500 includes a hard disk interface 508 and a removable memory interface 510, respectively coupling a hard disk drive 512 and a removable memory drive 514 to the system bus 506. Examples of removable memory drives 514 include magnetic disk drives and optical disk drives. The drives and their associated computer-readable media, such as a Digital Versatile Disc (DVD) 516 provide non-volatile storage of computer readable instructions, data structures, program modules and other data for the computer system 500. A single hard disk drive 512 and a single removable memory drive 514 are shown for illustration purposes only and with the understanding that the computing device 500 can include several similar drives. Furthermore, the computing device 500 can include drives for interfacing with other types of computer readable media.

The computing device 500 may include additional interfaces for connecting devices to the system bus 506. FIG. 5 shows a universal serial bus (USB) interface 518 which may be used to couple a device to the system bus 506. For example, an IEEE 1394 interface 520 may be used to couple additional devices to the computing device 500. Examples of additional devices include cameras for receiving images or video, and range finders for receiving range data.

The computing device 500 can operate in a networked environment using logical connections to one or more remote computers or other devices, such as a server, a router, a network personal computer, a peer device or other common network node, a wireless telephone or wireless personal digital assistant. The computing device 500 includes a network interface 522 that couples the system bus 506 to a local area network (LAN) 524. Networking environments are commonplace in offices, enterprise-wide computer networks and home computer systems.

A wide area network (WAN), such as the Internet, can also be accessed by the computing device, for example via a modem unit connected to a serial port interface 526 or via the LAN 524.

It will be appreciated that the network connections shown and described are exemplary and other ways of establishing a communications link between computers can be used. The existence of any of various well-known protocols, such as TCP/IP, Frame Relay, Ethernet, FTP, HTTP and the like, is presumed, and the computing device can be operated in a client-server configuration to permit a user to retrieve data from, for example, a web-based server.

The operation of the computing device can be controlled by a variety of different program modules. Examples of program modules are routines, programs, objects, components, and data structures that perform particular tasks or implement particular abstract data types. The present invention, may also be practiced with other computer system configurations, including hand-held devices, multiprocessor systems, microprocessor-based or programmable consumer electronics, network PCs, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

In various embodiments of the above described cases the image data from a set of monocular or stereo images is utilised to determine dense sets of exact spatial co-ordinates for each point in the three-dimensional model with high accuracy and speed. By merging several data sets it is possible to produce an accurate three-dimensional model with sufficient surface detail to identify structural features on the surface of the scanned object in real time or near real time. This is particularly advantageous for a number of applications in which differences in volume and/or shape of an object are involved.

The systems and methods described herein are particularly suited to medical or veterinary applications, such as reconstructive or cosmetic surgery where the tracking of the transformation of an anatomical feature or region of a body is required over a period of time. The system and method may also benefit the acquisition of three-dimensional dermatology images, including surface data, and enable accurate tracking of changes to various dermatological landmarks such as lesions, ulcerations, moles etc.

Utilising the three-dimensional models produced by the present invention it is possible to register surface models to other features within an image, or to other surface models such as those previously obtained for a given patient to calculate growth rates etc of various dermatological landmarks. With the present invention the particular landmark is referenced by its spatial co-ordinates. Any alterations to its size i.e. variance in external boundary, surface topology etc between successive imaging sessions can be determined by comparison of the data points for the referenced landmark at each time instance.

The above detailed description refers to scanning of an object. As will be readily understood by the skilled addressee, large objects can be scanned by moving the system to several distinct locations. An example includes a mine site, wherein images and depth data is captured from locations which may be separated by large distances.

The systems above have been described with reference to a fixed relationship between elements. However, as will be understood by the skilled addressee, elements of the systems may be moveable relative to each other.

It is to be understood that the above embodiments, have been provided only by way of exemplification of this invention, and that further modifications and improvements thereto, as would be apparent to persons skilled in the relevant art, are deemed to fall within the broad scope and ambit of the present invention described herein.

1. A method of generating a three-dimensional model of an object, the method including:
(a) capturing, using at least one image sensor and at least one range sensor, first image and range data corresponding to a first portion of the object from at least two different positions;
(b) generating, by a processor, a first three-dimensional model of the first portion of the object using the first image and range data;
(c) capturing, using at least one image sensor and at least one range sensor, second image and range data corresponding to a second portion of the object from at least two different positions, wherein the first and second portions are overlapping;
(d) generating, by a processor, a second three-dimensional model of the second portion of the object using the second image and range data; and
(e) generating, by a processor, a third three-dimensional model describing the first and second portions of the object by combining the first and second three-dimensional models into a single three-dimensional model.

2. A method of generating a three-dimensional model according to claim 1, wherein the first image and range data comprises range data that is of lower resolution than the image data.

3. A method of generating a three-dimensional model according to claim 1, further comprising:
estimating relative positions of the at least one image sensor at the at least two different positions by matching spatial features between images of the first image and range data.

4. A method of generating a three-dimensional model according to claim 3, further comprising:
estimating position and orientation data of the at least one image sensor and the at least one range sensor at a position of the least two different positions; and
partially initialising the matching of spatial features using the position and orientation data.

5. A method of generating a three-dimensional model according to claim 4, wherein the position and orientation data comprises a position determined relative to another position using acceleration data.

6. A method of generating a three-dimensional model according to claim 1, wherein the second image and range data is captured subsequently to generation of the first three-dimensional model.

7. A method of generating a three-dimensional model according to claim 1, wherein a position of the at least two positions from which the first image and range data is captured and a position of the at least two positions from which the second image and range data is captured comprise a common position.

8. A method of generating a three-dimensional model according to claim 1, wherein the first and second three-dimensional models are generated on a first device, and the third three-dimensional model is generated on a second device.

9. A method of generating a three-dimensional model according to claim 1, wherein capturing the range data comprises projecting a coded image onto the object, and analysing the reflected coded image.

10. A method of generating a three-dimensional model according to claim 1, further comprising: presenting, on a data interface, the third three-dimensional model.

11. A method of generating a three-dimensional model according to claim 1, further comprising:
generating a plurality of three dimension models at different time instances; and
determining, by comparing the plurality of three-dimensional models, changes to the object over time.

12. A system for generating a three-dimensional model of an object, the system including:
at least one processor;
at least one image sensor coupled to the at least one processor;
at least one range sensor coupled to the at least one processor; and
a memory coupled to the at least one processor, including instruction code executable by the at least one processor for:
(a) capturing, using the at least one image sensor and the at least one range sensor, first image and range data corresponding to a first portion of the object from at least two different positions;
(b) generating a first three-dimensional model of the first portion of the object using the first image and range data;
(c) capturing, using the at least one image sensor and the at least one range sensor, second image and range data corresponding to a second portion of the object from at least two different positions, wherein the first and second portions are overlapping;
(d) generating a second three-dimensional model of the second portion of the object using the second image and range data; and
(e) generating a third three-dimensional model describing the first and second portions of the object by combining the first and second three-dimensional models into a single three-dimensional model.

13. A system according to claim 12, wherein a range sensor of the at least one range sensor has a lower resolution than an image sensor of the at least one image sensor.

14. A system according to claim 12, wherein the range sensor comprises at least one of a lidar, a flash lidar, and a laser range finder.

15. A system according to claim 12, further comprising:
a sensor module, coupled to the at least one processor, for estimating position and orientation data of the at least one image sensor and the at least one range sensor;
wherein the feature matching is at least partly initialised using the position and orientation data.

16. A system according to claim 12, wherein the at least one processor, the at least one image sensor, the at least one range sensor, the processor and the memory are housed in a hand held device.

17. A system according to claim 12, wherein the first and second three-dimensional models are generated by a first processor of the at least one processor on a first device, and the third three-dimensional model is generated a second processor of the at least one processor on a second device.

18. A system according to claim 12, wherein the at least one range sensor comprises a projector, for projecting a coded image onto the object, and a sensor for analysing the projected coded image.

19. A system according to claim 12, further comprising a display screen, for displaying the third three-dimensional model.

20. A system for generating a three-dimensional model of an object, the system including:
a handheld device including:
a processor;
a network interface coupled to the processor;
an image sensor coupled to the processor;
a range sensor coupled to the processor; and
a memory coupled to the processor, including instruction code executable by the processor for:
capturing, using the image sensor and the range sensor, first image and range data corresponding to a first portion of the object from at least two different positions;
generating a first three-dimensional model of the first portion of the object using the first image and range data;
capturing, using the image sensor and the range sensor, second image and range data corresponding to a second portion of the object from at least two different positions, wherein the first and second portions are overlapping;
generating a second three-dimensional model of the second portion of the object using the second image and range data; and
transmitting, by the network interface, the first and second three-dimensional models;
a server including:
a processor;
a network interface coupled to the processor;
a memory coupled to the processor, including instruction code executable by the processor for:
receiving, on the network interface, the first and second three-dimensional models; and
generating a third three-dimensional model describing the first and second portions of the object by combining the first and second three-dimensional models into a single three-dimensional model.
